(19) United States
(12) Patent Application Publication
(10) Pub. No.: US 2025/0202138 A1
(43) Pub. Date: Jun. 19, 2025

(54) CONDUCTOR ASSEMBLY HAVING A SLEEVE

(71) Applicant: ENNOVI INDUSTRIES, INC., East Providence, RI (US)

(72) Inventor: Richard SCHNEIDER, Livonia, MI (US)

(21) Appl. No.: 18/845,671

(22) PCT Filed: Mar. 6, 2023
(86) PCT No.: PCT/US2023/014596

§ 371 Date: Sep. 10, 2024

Related U.S. Application Data
(60) Provisional application No. 63/319,447, filed on Mar. 14, 2022.

(51) Int. Cl. H01R 4/48; H01R 4/20; H01R 4/62; H01R 12/71

(52) U.S. Cl. CPC H01R 4/48; H01R 4/20; H01R 4/62; H01R 12/718; H01R 2201/10

(57) ABSTRACT

An electric current conductor assembly having first and second electric conductors. The first electric conductor has a connection portion that includes a pair of spaced-apart arms defining a receptacle in-between. The second electric conductor is at least partially disposed in the receptacle of the first electric conductor. A sleeve is disposed over the first electric conductor and applies inward forces against the arms to bias the arms toward each other, with the second electric conductor held in-between. The electric current conductor assembly may be a tuning fork-type conductor assembly, or a combination of a tuning fork-type conductor assembly and an IDT-type conductor assembly.

### CROSS-REFERENCE TO RELATED APPLICATION(S)

This application claims the benefit of priority under 35 U.S.C. § 119 (e) to U.S. Provisional Patent Application No. 63/319,447 filed on 14 Mar. 2022, which is herein incorporated by reference.

### TECHNICAL FIELD

This disclosure relates generally to a conductor assembly having two parts connected together to convey power and, more particularly, to such a connector assembly in which at least one of the parts is at least partially rigid.

### BACKGROUND

Rigid conductors, such as bus bars, are commonly used to provide power to electrical and electronic components. Conventionally, a rigid conductor is a bar composed of a conductive metal, such as copper or a copper alloy, and is relatively wide and thick to better conduct electric current. Due to its composition and configuration, a rigid conductor is difficult to establish a secure electrical connection to. Typically, connections are made using large, complicated connectors that require numerous openings to be formed in the rigid conductors. Moreover, such connectors do not readily accommodate different orientations of the conductors or accommodate misalignment between the conductors. As such, it would be desirable to have a conductor assembly that utilizes a connector that is compact and permits a rigid conductor to be connected to another conductor in different orientations and to accommodate misalignment between the two conductors. The present disclosure is directed to such a conductor assembly.

### SUMMARY

In accordance with the disclosure, an electric current conductor assembly is provided having first and second electric conductors. The first electric conductor has a connection portion that includes a pair of spaced-apart arms defining a receptacle in-between. The second electric conductor is at least partially disposed in the receptacle of the first electric conductor. A sleeve is disposed over the first electric conductor and applies inward forces against the arms to bias the arms toward each other, with the second electric conductor held in-between.

### BRIEF DESCRIPTION OF THE DRAWINGS

The features, aspects, and advantages of the present invention will become better understood with regard to the following description, appended claims, and accompanying drawings where:

FIG. 1 shows a perspective view of a first conductor assembly constructed in accordance with a first embodiment, wherein some of the components are separated;

FIG. 2 shows a perspective view of a portion of the first conductor assembly of FIG. 1;

FIG. 3 shows a perspective view of a second conductor assembly constructed in accordance with a second embodiment, wherein some of the components are separated;

FIG. 4 shows a perspective view of the second conductor assembly of FIG. 3 in an assembled configuration;

FIG. 5 shows a perspective view of a third conductor assembly constructed in accordance with a third embodiment;

FIG. 6 shows a perspective view of a portion of the third conductor assembly of FIG. 5, wherein some of the components are separated;

FIG. 7 shows a perspective view of a fourth conductor assembly constructed in accordance with a fourth embodiment, wherein the fourth conductor assembly is surface mounted to a printed circuit board and a second conductor is spaced above the rest of the fourth conductor assembly;

FIG. 8 shows a sectional view of the fourth conductor assembly of FIG. 7, wherein the second conductor is mounted to a first conductor;

FIG. 9 shows a perspective view of a portion of the fourth conductor assembly of FIG. 7, wherein the components are separated;

FIG. 10 shows a perspective view of another portion of the fourth conductor assembly of FIG. 7, wherein the components are separated;

FIG. 11 shows a perspective view of a portion of a fifth conductor assembly constructed in accordance with a fifth embodiment, wherein components are separated;

FIG. 12 shows a perspective view of the fifth conductor assembly mounted to a printed circuit board, wherein a second conductor is spaced above the rest of the fifth conductor assembly;

FIG. 13 shows a perspective view of a portion of a sixth conductor assembly constructed in accordance with a sixth embodiment, wherein components are separated;

FIG. 14 shows a perspective view of the sixth conductor assembly surface mounted to a printed circuit board, wherein a second conductor is space above the rest of the assembly;

FIG. 15 shows a perspective view of a portion of an electric motor, wherein components are separated;

FIG. 16 is front perspective view of a portion of an expanded conductor assembly having features of the fourth conductor assembly of FIG. 7 and features of an insulation displacement connector (IDC);

FIG. 17 is a front, side perspective view of a portion of the expanded conductor assembly of FIG. 16, wherein components are separated; and

FIG. 18 shows a perspective view of an insulation displacement terminal (IDT) of the IDC, wherein the IDT is spaced from a sleeve.

### DETAILED DESCRIPTION OF ILLUSTRATIVE EMBODIMENTS

It should be noted that in the detailed description that follows, identical components have the same reference numerals, regardless of whether they are shown in different embodiments of the present disclosure. It should also be noted that for purposes of clarity and conciseness, the drawings may not necessarily be to scale and certain features of the disclosure may be shown in somewhat schematic form.

Spatially relative terms, such as “top”, “bottom”, “lower”, “above”, “upper”, and the like, are used herein merely for ease of description to describe one element or feature's relationship to another element(s) or feature(s) as they are illustrated in (a) drawing figure(s) being referred to. It will be understood that the spatially relative terms are not meant to be limiting and are intended to encompass different orientations of the device in use or operation in addition to the orientation depicted in the drawings.

Generally, the conductor assembly of the present disclosure utilizes a sleeve to connect a first conductor to a second conductor, wherein the first conductor has a portion with spaced apart beams or arms that receive a portion of the second conductor in-between. The sleeve is disposed over and at least partially encloses the first conductor. The first and second conductors are formed from a conductive metal, such as copper or a copper alloy. The first conductor is at least partially rigid. The sleeve is thin and formed from stainless steel, phosphor bronze or other spring-type alloy.

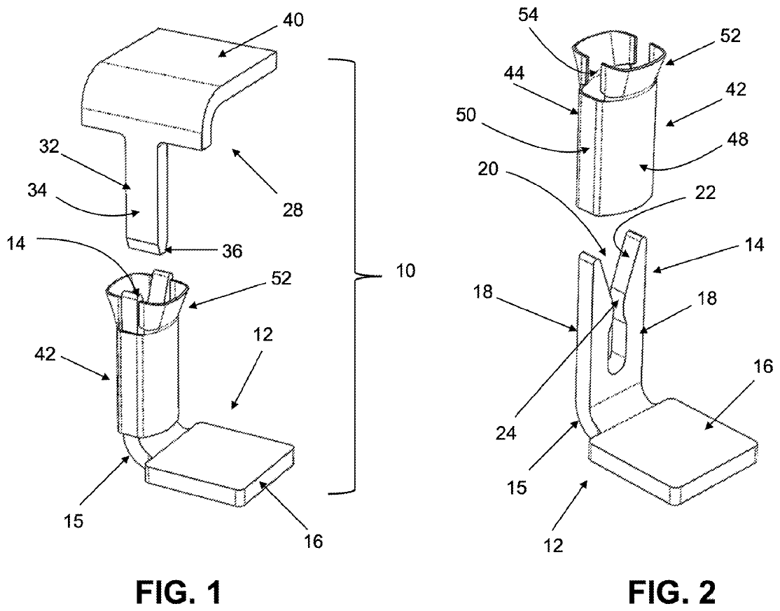

Referring now to FIGS. 1-2, there is shown a first embodiment of the conductor assembly (designated with the reference numeral 10) and components thereof. In the first conductor assembly 10, the first conductor (designated by the reference numeral 12) has a bifurcated end portion 14 that is joined at a bend 15 to a main portion 16 so as to be disposed at about a right angle thereto. The first conductor 12 may be a busbar in which the main portion 16 is more elongated than shown and may be bar-shaped. Alternately, the first conductor 12 may be a connector in which the main portion 16 may be a pad (as shown) that is adapted for surface mounting to another metal pad, such as on a printed circuit board (PCB). The end portion 14 includes arms 18 separated by a space or receptacle 20. The arms 18 each have opposing planar surfaces and an irregular-shaped interior edge 22 that includes an inner portion joined by a bulbous center portion 24 to an outer portion. The inner portions are substantially straight, while the outer portions slope inwardly toward the center portions 24. In this manner, the inner portions provide the receptacle 20 with a narrow slot portion, while the outer portions provide the receptacle 20 with a V-shaped receiving portion. The center portions 24 are closely arranged to define a contact zone, which is the narrowest portion of the receptacle 20. The receptacle 20 extends through the opposing planar surfaces of the arms 18.

The second conductor (designated by the reference numeral 28) has an end portion comprising an elongated tongue 32 having opposing major surfaces 34 and a beveled free end 36. The end portion is joined at a bend to a main portion 40 so as to be disposed at about a right angle thereto. As with the first conductor 12, the second conductor 28 may be a busbar in which the main portion 40 is more elongated than shown and may be bar-shaped. Alternately, the second conductor 28 may be a connector in which the main portion 40 may be a pad (as shown) that is adapted for surface mounting to another metal pad, such as on a printed circuit board (PCB).

The sleeve (designated by the reference numeral 42) includes a main body 44 that may generally have the shape of an elliptic cylinder. The main body 44 has opposing arcuate main walls 48 joined together by opposing straight side walls 50. A funnel-shaped collar 52 is joined to a first end of the main body 44. The collar 52 has opposing slots 54 formed therein that divide the collar 52 into two portions. The flared shape of the collar 52 helps guide the tongue 32 of the second conductor 28 into the receptacle 20 of the first conductor 12, such as when the two conductors are slightly misaligned. The sleeve 42 defines an interior space that is configured to tightly receive a width of the end portion 14 of the first conductor 12 in the direction between the side walls 50.

As generally described above, the sleeve 42 is thin and formed from stainless steel, phosphor bronze or other spring-type alloy. The sleeve 42 may be fabricated from a length of tubing (either seamless or welded seam) that is formed and cut. Alternately, the sleeve 42 may be cut and formed from flat stock, then welded together. The weld can be straight (as shown), or include a puzzle latch. The sleeve 42 is elastically deformable and, thus, may operate as a spring to apply forces on the second conductor 28, as will be described below. The sleeve 42 is substantially thinner than the first and second conductors 12, 28. More specifically, the sleeve 42 is at least half as thick as the thinnest portion of the first and second conductors 12, 28. In particular, the sleeve 42 is at least half as thick as each of the arms 18 of the first conductor 12, both in a direction between the interior and exterior edges of each arm 18 and in a direction normal to that direction, i.e., in the direction between the planar surfaces of each arm 18.

The first and second conductors 12, 28 may be connected together to form the conductor assembly 10 in the following manner. The sleeve 42 is disposed over the end portion 14 of the first conductor 12 such that exterior edges of the arms 18 adjoin the straight side walls 50 of the sleeve 42 and are aligned with the slots 54 in the collar 52. First edges of the arms 18 project slightly above a top of the collar 52, while a bottom edge of the main body 44 is disposed close to the bend 15.

The tongue 32 of the second conductor 28 is pressed into the receptacle 20 of the first conductor 12 such that the bevels of its free end 36 slide over the center portions 24 of the interior edges 22 of the arms 18, thereby applying forces against the arms 18 to move them outward, against the bias of the sleeve 42. As a result, the sleeve 42 elastically deforms to accommodate the expanded arms 18. The sleeve 42 exerts inwardly-directed spring forces against the arms 18 of the first conductor 12, thereby clamping the tongue 32 of the second conductor 28 between the center portions 24 of the arms 18. In this manner, the first and second conductors 12, 28 are electrically and mechanically connected together.

The conductor assembly 10 may be referred to as a tuning fork-type conductor assembly since it includes a conductor with a bifurcated end portion. Other tuning fork-type conductor assemblies are described below.

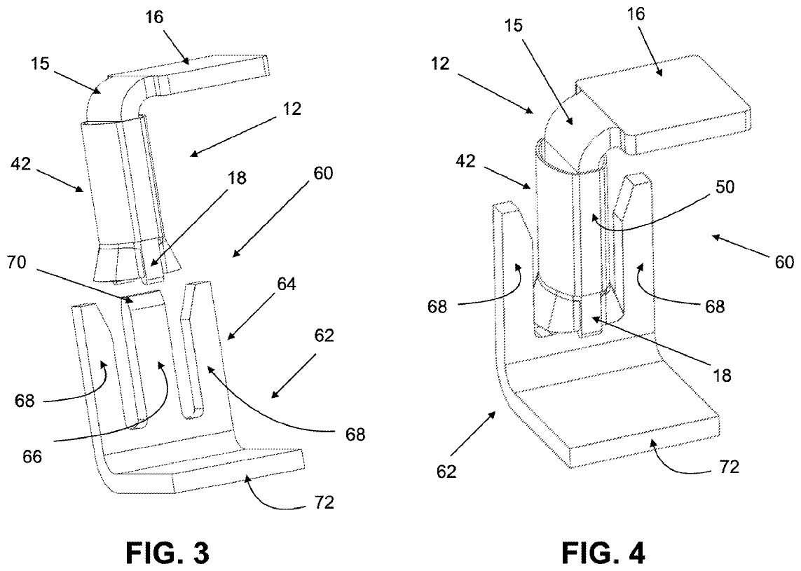

Referring now to FIGS. 3-4, there is shown a second conductor assembly 60 constructed in accordance with a second embodiment of the disclosure. The second conductor assembly 60 has the same components, construction and assembly as the conductor assembly 10, except as specifically described below. Instead of having the second conductor 28, the second conductor assembly 60 has a second conductor 62, which may also be a busbar or a connector. The second conductor 62 has an end portion 64 with at least three tines, such as a middle tine 66 and two outer tines 68. The middle tine 66 has a tapered free end 70, while the outer tines 68 each have inner edges with upper portions that slope downwardly and inwardly from first ends. The end portion 64 is joined at a bend to a main portion 72 so as to be disposed at about a right angle thereto.

The second conductor 62 may be a busbar in which the main portion 72 is more elongated than shown and may be bar-shaped. Alternately, the second conductor 62 may be a connector in which the main portion 72 may be a pad (as shown) that is adapted for surface mounting to another metal pad, such as on a printed circuit board (PCB).

The first and second conductors 12, 62 are connected together to form the conductor assembly 60 in the following manner. The sleeve 42 is disposed over the end portion 14 of the first conductor 12 such that exterior edges of the arms 18 adjoin the straight side walls 50 of the sleeve 42 and are aligned with the slots 54. The combination of the end portion 14 and the sleeve 42 mounted thereto is then engaged with the end portion 64 of the second conductor 62 such that the combination moves between the outer tines 68 and over the middle tine 66. In this regard, the outer tines 68 and their sloping edges help guide the middle tine 66 into the receptacle 20 of the combination. As the middle tine 66 moves through the receptacle 20 of the first conductor 12, the bevels of its free end 70 slide over the center portions 24 of the interior edges 22 of the arms 18, thereby applying forces against the arms 18 to move them outward, against the bias of the sleeve 42. As a result, the sleeve 42 elastically deforms to accommodate the expanded arms 18. The sleeve 42 exerts inwardly-directed spring forces against the arms 18 of the first conductor 12, thereby securely clamping the middle tine 66 of the second conductor 28 between the center portions 24 of the arms 18. In this manner, the first and second conductors 12, 62 are electrically and mechanically connected together.

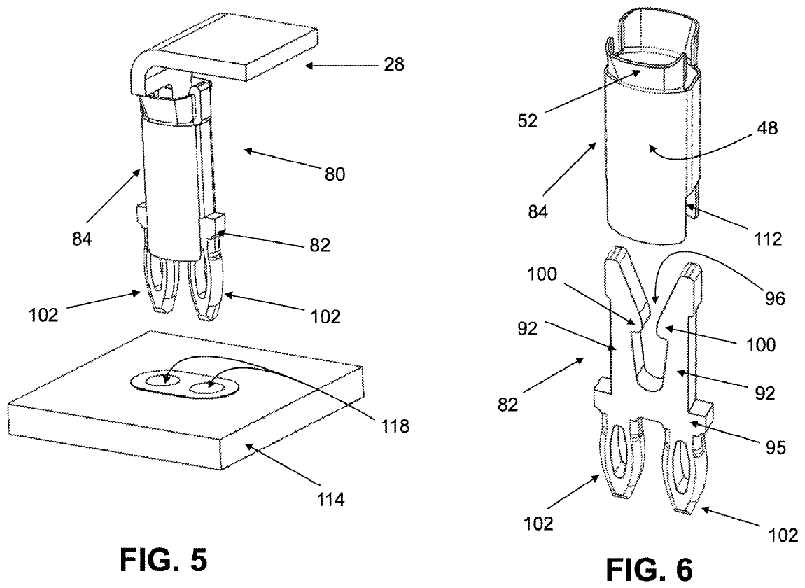

FIGS. 5-6 shows a third conductor assembly 80 constructed in accordance with a third embodiment of the disclosure. The third conductor assembly 80 includes a first conductor 82, a second conductor 28 and a sleeve 84. The first conductor 82 is a connector that is plate-shaped, with opposing planar surfaces, and has the construction described below. The first conductor 82 is configured for connection to a printed circuit board.

The first conductor 82 has a first connection portion joined to a second connection portion. The first connection portion is bifurcated and includes arms 92, which are separated by a space or receptacle 96 and are joined to a bar 95. Each arm 92 has an irregular-shaped interior edge that includes an inner portion joined by a bulbous center portion 100 to an outer portion. The inner portions are substantially straight, while the outer portions slope inwardly toward the center portions 100. In this manner, the inner portions provide the receptacle 96 with a narrow slot portion, while the outer portions provide the receptacle 96 with a V-shaped receiving portion. The center portions 100 are closely arranged to define a contact zone, which is the narrowest portion of the receptacle 96.

The second connection portion includes a pair of press-fit fasteners 102 joined to the bar 95. The press-fit fasteners 102 may each have an eye-of-the-needle (EON) construction. In this type of construction, an opening or piercing is formed in the fastener 102 so as to define a pair of beams that are resiliently movable toward and away from each other to provide a normal force against a hole in a substrate, such as the hole in a printed circuit board (PCB). Another type of construction that may be used for the press-fit fasteners 102 utilizes beams that are connected together by a web that permits the beams to roll inward to conform to the PCB hole. A particularly suitable web-type of construction that may be used for the press-fit fasteners 102 is shown in U.S. Pat. No. 11,095,057 to Parrish, which is herein incorporated by reference. In this construction, each fastening section includes a pair of beams with a web joined in-between. The web has a center portion disposed between a pair of sloping ramp portions. A pair of holes may extend through the center portion.

The sleeve 84 has the same construction as the sleeve 42, except for the differences described below. The sleeve 84 has a pair of slots 112 formed in the side walls 50, respectively, toward a second end of the main body 44. As will be described more fully below, the slots 112 accommodate the bar 95.

The first and second conductors 82, 28 may be connected together to form the third conductor assembly 80 in the following manner. The sleeve 84 is disposed over the first conductor 82 such that the bar 95 extends through the slots 112 and presses against edges of the main body 44 that help form the slots 112. In addition, exterior edges of the arms 18 adjoin the straight side walls 50 of the sleeve 42 and are aligned with the slots 54. The press-fit fasteners 102 project from a bottom end of the main body 44. The combination of the first conductor 82 and the sleeve 82 mounted thereto is then engaged with a printed circuit board (PCB) 114 to push the press-fit fasteners 102 into holes 118 of the PCB 114, respectively, thereby securing the combination to the PCB 114.

With the combination so secured to the PCB 114, the tongue 32 of the second conductor 28 is pressed into the receptacle 96 of the first conductor 82 such that the bevels of its free end 36 slide over the center portions 100 of the interior edges of the arms 92, thereby applying forces against the arms 92 to move them outward, against the bias of the sleeve 84. As a result, the sleeve 84 elastically deforms to accommodate the expanded arms 92. The sleeve 84 exerts inwardly-directed spring forces against the arms 92 of the first conductor 82, thereby clamping the tongue 32 of the second conductor 28 between the center portions 100 of the arms 92. In this manner, the first and second conductors 82, 28 are electrically and mechanically connected together.

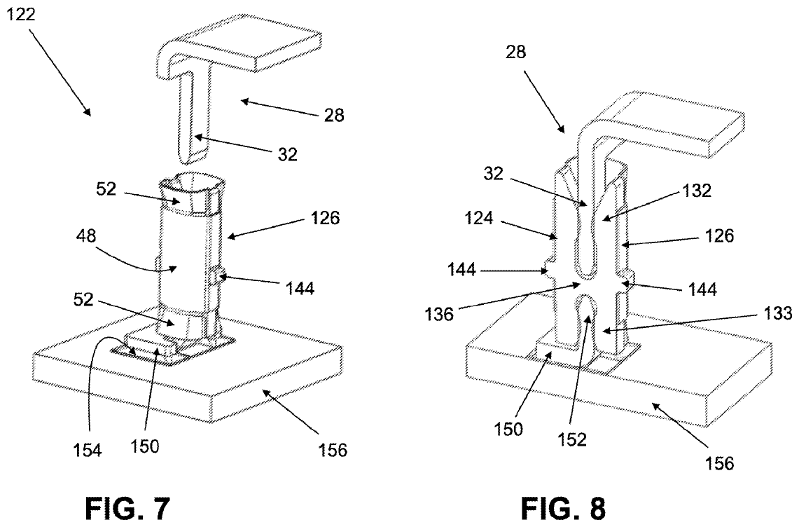

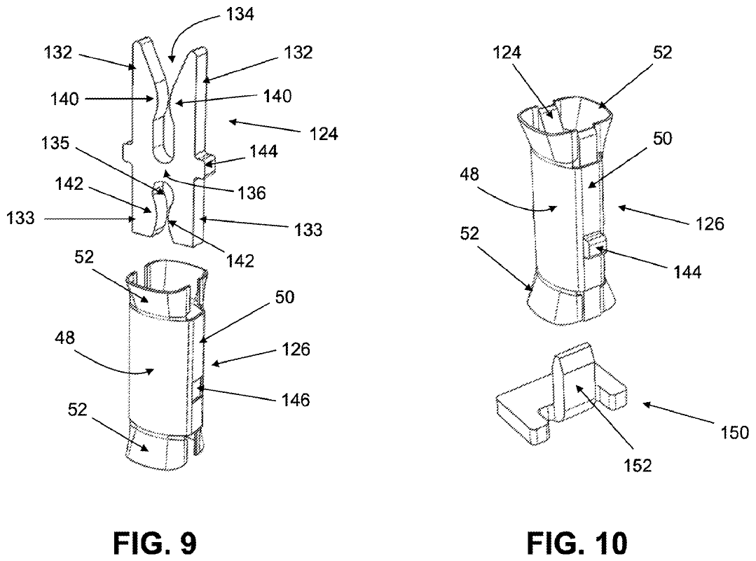

Another conductor assembly embodiment is shown in FIGS. 7-10 and is designated by the reference numeral 122. The (fourth) conductor assembly 122 includes a first conductor 124, a second conductor 28 and a sleeve 126. The first conductor 124 is a connector that is plate-shaped, with opposing planar surfaces, and has the construction described below. The first conductor 124 is configured to be pivotable to better accommodate misalignment, as described more fully below.

The first conductor 124 has a first connection portion joined to a second connection portion. The first connection portion is bifurcated and includes arms 132 that are separated by a space or receptacle 134 and are joined to a body 136. Similarly, the second connection portion is bifurcated and includes arms 133 that are separated by a space or receptacle 135 and are joined to the body 136. Protrusions 144 extend outwardly from opposing sides of the body 136. Each arm 132, 133 has an irregular-shaped interior edge that includes an inner portion joined by a bulbous center portion to an outer portion. The center portions are closely arranged to define a contact zone, which is the narrowest portion of the receptacle 134 or 135. In the first connection portion, the outer portions of the arms 132 provide the receptacle 134 with a V-shaped receiving portion.

The sleeve 126 has the same construction as the sleeve 42, except for the differences described below. The sleeve 126 has a second collar 52 joined to a second end of the main body 44. The sleeve 126 also has rectangular openings 146 formed in the side walls 50, respectively, toward the second end of the main body 44. As will be described more fully below, the openings 146 accommodate the protrusions 144, respectively.

The first and second conductors 124, 28 may be connected together by first mounting the sleeve 126 to the first conductor 124. To do so, the second end of the sleeve 126 is aligned over the first connection portion of the first conductor 124 and then is pressed downward. As the sleeve 126 is pressed downward, the sleeve 126 moves over the first conductor 124 and is temporarily deformed by the protrusions 144 in the direction between the side walls 50 so as to permit the protrusions 144 to enter the openings 146 and extend at least partially therethrough. In addition, exterior edges of the arms 132, 133 adjoin the straight side walls 50 of the sleeve 126 and are aligned with the slots 54 in the first and second collars 52.

A blade 152 of a mount 150 may be inserted through the second collar 52 and pressed into the receptacle 135 of the second connection portion of the first conductor 124. The movement of the blade 152 between the center portions 142 of the arms 133 applies forces against the arms 133 to move them outward, against the bias of the sleeve 126. As a result, the sleeve 126 elastically deforms to accommodate the expanded arms 133.

Before or after the mount 150 is connected to the combination of the sleeve 126 and the first conductor 124, a planar bottom surface of the mount 150 may be soldered to a metal conductor pad 154 of a PCB 156 to electrically and mechanically connect the mount 150 to the PCB 156.

The second connector 28 may then be connected to the combination of the sleeve 126 and the first conductor 124. The tongue 32 of the second conductor 28 is inserted through the first collar 52 and pressed into the receptacle 134 of the first conductor 124 such that the bevels of its free end 36 slide over the center portions 140 of the interior edges of the arms 132, thereby applying forces against the arms 132 to move them outward, against the bias of the sleeve 126. As a result, the sleeve 126 elastically deforms to accommodate the expanded arms 132.

The sleeve 126 exerts inwardly-directed spring forces against the arms 132, 133 of the first conductor 124, thereby clamping the tongue 32 of the second conductor 28 between the center portions 140 of the arms 132 and clamping the blade 152 of the mount 150 between the center portions 142 of the arms 133. In this manner, the first and second conductors 124, 28 are electrically and mechanically connected together.

The construction of the fourth conductor assembly 122 permits the first conductor 124 to pivot about the blade 152 and/or the tongue 32 to accommodate angular and translational misalignment of the second conductor 28 and the mount 150.

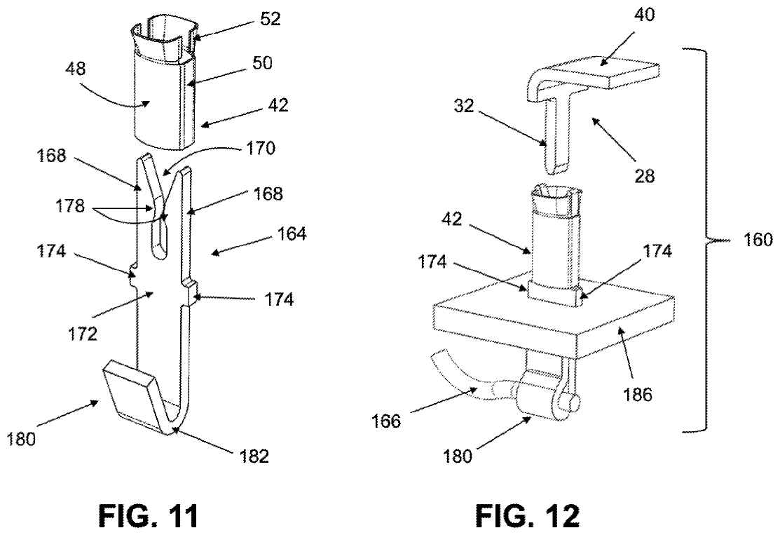

Still another conductor assembly embodiment is shown in FIGS. 11-12 and is designated as a fifth conductor assembly 160. The fifth conductor assembly 160 includes a first conductor 164, a second conductor 28 and a sleeve 42. The first conductor 164 is a wire connector having the construction described below. The first conductor 164 is configured to be crimped over a metal wire 166 to make a connection thereto.

The first conductor 164 has a first connection portion joined to a second connection portion. The first connection portion is bifurcated and includes arms 168 which are separated by a space or receptacle 170 and are joined to a body 172. Protrusions 174 extend outwardly from opposing sides of the body 172. Each arm 168 has an irregular-shaped interior edge that includes an inner portion joined by a bulbous center portion 178 to an outer portion. The center portions 178 are closely arranged to define a contact zone, which is the narrowest portion of the receptacle 170. In the first connection portion, the outer portions of the arms 168 provide the receptacle 170 with a V-shaped receiving portion.

The second connection portion extends from the body 172 and includes a holding portion 180 in which a bend 182 may be formed. The holding portion 180 is originally straight and plate-shaped before it is bent and crimped. The holding portion 180 is tick or hook shaped and is initially open to permit the wire 166 to be disposed in the bend 182. After the wire 166 is disposed in the bend 182, an end of the holding portion 180 is bent or crimped to close the holding portion 180 and trap the wire 166 inside.

The sleeve 42 is disposed over the first connection portion of the first conductor 164 such that exterior edges of the arms 168 adjoin the straight side walls 50 of the sleeve 42 and are aligned with the slots 54 in the collar 52.

The second connector 28 is connected to the combination of the sleeve 42 and the first conductor 164 by inserting the tongue 32 of the second conductor 28 through the first collar 52 and into the receptacle 170 of the first conductor 164. The tongue 32 is pressed into the receptacle 170 such that the bevels of its free end 36 slide over the center portions 178 of the interior edges of the arms 168, thereby applying forces against the arms 168 to move them outward, against the bias of the sleeve 42. As a result, the sleeve 42 elastically deforms to accommodate the expanded arms 168. The sleeve 42 exerts inwardly-directed spring forces against the arms 168 of the first conductor 164, thereby clamping the tongue 32 of the second conductor 28 between the center portions 178 of the arms 168. In this manner, the first and second conductors 164, 28 are electrically and mechanically connected together.

The fifth conductor assembly 160 may be mounted to a substrate 186, such as a PCB, as shown in FIG. 12. The mounting may be performed by inserting the unbent holding portion 180 through a slot in the substrate 186. The protrusions 174 abut the substrate 186 adjacent to the slot and support the first conductor 164 on the substrate 186. After being inserted through the slot, the holding portion 180 may be bent and then crimped to clamp the wire 166. When the fifth conductor assembly 160 is mounted to the substrate 186, the first conductor 164 extends through the substrate 186 to connect the second conductor 28, which is disposed above the substrate 186 to the wire 166, which is disposed below the substrate 186.

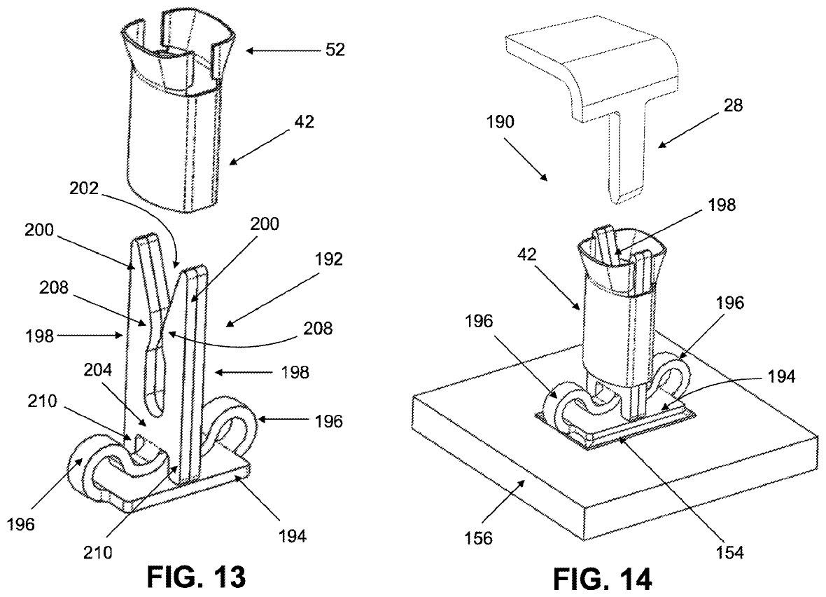

In a sixth embodiment shown in FIG. 13-14, a sixth busbar assembly 190 is provided in which a second conductor 28 is connected to a pad 154 of a PCB 156 directly using a first conductor 192. The sixth busbar assembly 190 includes a sleeve 42 as well as the second conductor 28 and the first conductor 192.

The first conductor 192 may be a unitary structure formed from a single piece of metal such as through stamping. The first conductor 192 includes a base plate 194 having opposing ends, each of which is joined by a loop 196 to a connection structure 198. Each connection structure 198 is flat and has opposing planar surfaces. In addition, each connection structure 198 includes arms 200 which are separated by a space or receptacle 202 and are joined to a body 204. Each arm 200 has an irregular-shaped interior edge that includes an inner portion joined by a bulbous center portion 208 to an outer portion. In each connection structure 198, the center portions 208 are closely arranged to define a contact zone, which is the narrowest portion of the receptacle 202. Outer portions of the arms 200 in each connection structure 198 provide the receptacle 202 with a V-shaped receiving portion. A pair of short legs 210 are joined to the body 204 of each connection structure 198 and extend downwardly therefrom. In each connection structure 196, a loop 196 is joined to the body 204 in-between the legs 210. The loops 196 may act as springs when the tongue 32 of the second conductor 28 is inserted into the receptacles 202, as described below.

The connection structures 198 are arranged such that they are aligned with each other and have inner ones of their planar surfaces adjoining each other. The connection structures 198 may be secured to each other such as through welding. Since the connection structures 198 are aligned, their receptacles 202 are aligned to form a combined receptacle, which may also use the reference number 202.

The sleeve 42 is disposed over the first conductor 192 such that exterior edges of the arms 200 adjoin the straight side walls 50 of the sleeve 42 and are aligned with the slots 54 in the collar 52. After the sleeve 42 is connected to the first conductor 192, a planar bottom surface of the base plate 194 may be soldered to the metal conductor pad 154 of a PCB 156 to electrically and mechanically connect the first conductor 192 to the PCB 156.

The second connector 28 is connected to the combination of the sleeve 42 and the first conductor 192 by inserting the tongue 32 of the second conductor 28 through the first collar 52 and into the receptacle 202 of the first conductor 192. The tongue 32 is pressed into the receptacle 202 such that the bevels of its free end 36 slide over the center portions 208 of the interior edges of the arms 200, thereby applying forces against the arms 200 to move them outward, against the bias of the sleeve 42. As a result, the sleeve 42 elastically deforms to accommodate the expanded arms 200. The sleeve 42 exerts inwardly-directed spring forces against the arms 200 of the first conductor 164, thereby clamping the tongue 32 of the second conductor 28 between the center portions 208 of the arms 200. In this manner, the first and second conductors 192, 28 are electrically and mechanically connected together.

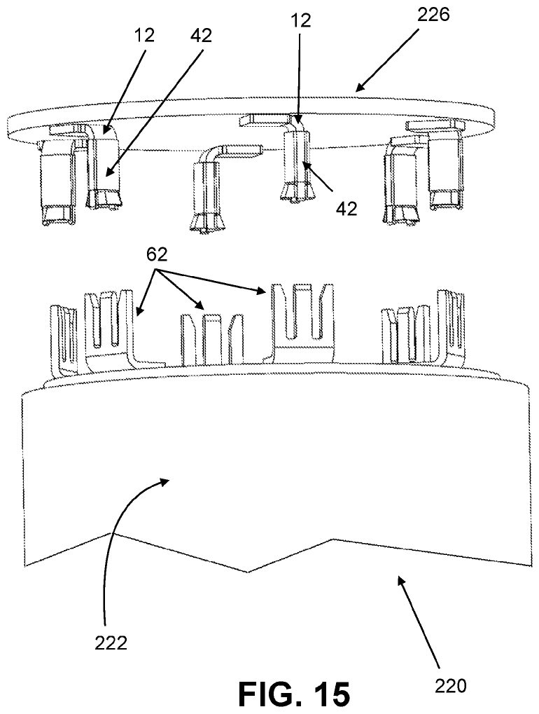

The foregoing tuning fork conductor assemblies are especially suitable for connecting together modular components in a plug-in-type manner, wherein the modular components are difficult to align. An example of such modular components is shown in FIG. 15, which depicts electric motor components being connected together. More specifically, FIG. 15 shows an electric motor 220 having an outer housing 222 from which a plurality of second conductors 62 extend and which are aligned for connection with power connectors of a PCB 226 for distributing power. The power connectors each include a first conductor 12 with a sleeve 42 mounted thereto. The main portions 16 of the conductors 12 are surface mounted (such as by soldering) to metal pads of the PCB 226.

The electric motor 220 and the PCB 226 are brought together to insert the middle tines 66 of the second conductors 62 into the receptacles 20 of the first conductors 12. The flared collars 52 of the sleeves 42, in combination with the outer tines 68 of the second conductors, accommodate any misalignment and help guide the middle tines 66 into the receptacles 20.

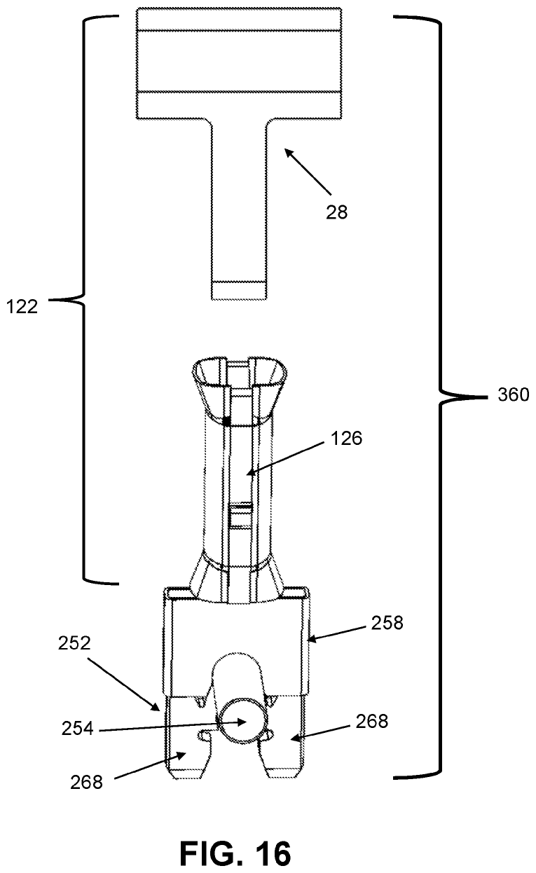

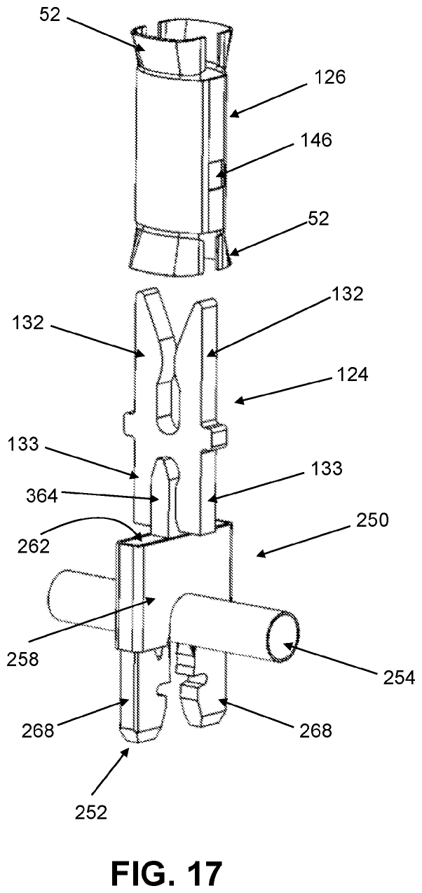

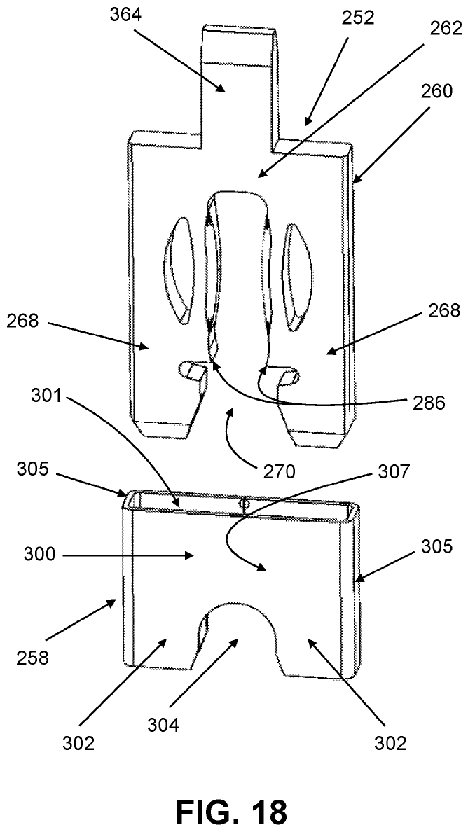

It should also be appreciated that expanded conductor assemblies can be provided that combine features of a tuning fork-type conductor assembly and a conductor assembly having an insulation displacement terminal (IDT). One such expanded conductor assembly 360 and its components are shown in FIGS. 16-18. The expanded conductor assembly 360 may include an IDT-type conductor assembly 250 connected to the tuning fork-type conductor assembly 122.

The conductor assembly 250 includes an IDT 252, an insulated wire 254 and a sleeve 258. The conductor assembly 250 may further include a housing (not shown). The wire 254 has an outer insulating sheath or layer that encases a metal conductor, such as copper wire.

The IDT 252 has a low profile and includes one or more conductor plates 260. Each conductor plate 260 has a monolithic unitary structure and is composed of electrically conductive metal, such as copper or a copper alloy, which may or may not be plated with tin. The conductor plate 260 may, by way of non-limiting example, be formed by stamping. Although a single conductor plate 260 is shown in FIGS. 16-18, it should be appreciated that in other embodiments, a plurality of conductor plates 260 may be provided. In these other embodiments, the conductor plates 260 are arranged in a stack in which they may directly contact each other or be separated by thin dielectric layers.

The conductor plate 260 includes a base 262 having a pair of engagement legs 268 extending in a first direction therefrom. A blade projection 364 extends in a second (opposite) direction from a top edge of the base 262. Each engagement leg 268 of the conductor plate 260 has an upper portion joined to the base 262 and a lower portion forming a free end. The engagement legs 268 are spaced-apart to form a slot 270 therebetween. Sharp cutting edges 286 are formed in the legs 268 and extend in the direction of the thickness of the conductor plate 260. The cutting edges 286 function as scrapers and/or cutters for piercing the insulation layer of the wire 254.

The sleeve 258 has the shape of a pair of short trousers, with a waist portion 300 joined to a pair of leg portions 302 separated by a center passage 304. The waist portion 300 has an opening 301 defined by a continuous edge. Opposing side walls 305 and opposing major walls 307 define both the waist portion 300 and the leg portions 302. The sleeve 258 defines an interior space that is configured to tightly receive the width of the IDT 252 (conductor plate(s) 260) in the direction between the side walls 305.

As generally described above, the sleeve 258 is thin and formed from stainless steel, phosphor bronze or other spring-type alloy. The sleeve 258 may be fabricated from a length of tubing (either seamless or welded seam) that is formed and cut. Alternately, the sleeve 258 may be cut and formed from flat stock, then welded together. The weld can be straight or include a puzzle latch. The sleeve 258 is substantially thinner than the conductor plate 260. More specifically, the sleeve 258 is at least half as thick as a conductor plate 260. The sleeve 258, however, is not flexible, but rather provides inwardly-directed reaction forces to the outwardly-directed forces from the elastic engagement legs 268 of the conductor plate 260 and their cutters 286 when they engage the wire 254.

It is to be understood that the description of the foregoing exemplary embodiment(s) is (are) intended to be only illustrative, rather than exhaustive. Those of ordinary skill will be able to make certain additions, deletions, and/or modifications to the embodiment(s) of the disclosed subject matter without departing from the spirit of the disclosure or its scope.

1. An electric current conductor assembly comprising:
a first electric conductor having a connection portion with a pair of spaced-apart arms defining a receptacle in-between;
a second electric conductor at least partially disposed in the receptacle of the first electric conductor; and
a sleeve disposed over the first electric conductor and applying inward forces against the arms to bias the arms toward each other, with the second electric conductor held in-between.

2. The conductor assembly of claim 1, wherein the sleeve is constructed of a first metal and the first electric conductor is constructed of a second metal, and wherein the first and second metals are different.

3. The conductor assembly of claim 2, wherein the first metal comprises stainless steel or phosphor bronze and the second metal comprises copper or a copper alloy.

4. The conductor assembly of claim 2, wherein the sleeve is thinner than the thickness of each of the arms of the first electric conductor in a direction normal to the direction in which the arms extend and normal to the direction between the arms.

5. The conductor assembly of claim 1, wherein the sleeve has a peripheral portion that extends around the arms of the first electric conductor along at least a portion of the length of the arms.

6. The conductor assembly of claim 5, wherein the peripheral portion comprises a continuous wall having arcuate portions.

7. The conductor assembly of claim 6, wherein the arcuate portions of the continuous wall are joined between planar side portions;
wherein the planar side portions of the continuous wall press against exterior edges of the arms, respectively; and
wherein the second electrical conductor comprises a tongue having opposing planar surfaces adjoining interior edges of the arms of the first conductor.

8. The conductor assembly of claim 7, wherein the sleeve has at least one collar that is joined to an end of the continuous wall and slopes outward therefrom.

9. The conductor assembly of claim 5, wherein the arms of the first electric conductor have interior edges, respectively, which help define the receptacle, the interior edges each having a holding portion that extends inwardly farther than the rest of the interior edge such that the holding portions define the narrowest portion of the receptacle.

10. The conductor assembly of claim 9, wherein the arms of the first electric conductor are first arms and the receptacle is a first receptacle; and
wherein the first electric conductor comprises a second connection portion with a pair of spaced-apart second arms defining a second receptacle in-between.

11. The conductor assembly of claim 10, further comprising a blade that is disposed in the second receptacle and about which the first electric conductor is pivotable.

12. The conductor assembly of claim 11, wherein the blade is integrally joined to, and extends upwardly from, a base having a planar surface configured for surface mounting to a metal pad of a printed circuit board; and
wherein the sleeve extends around the second arms of the first electric conductor along at least a portion of the length of the second arms.

13-14. (canceled)

15. The conductor assembly of claim 1, further comprising an additional first electric conductor comprising a connection portion with a pair of spaced-apart arms defining a receptacle in-between;
wherein the first electric conductor and the additional first electric conductor each have opposing planar surfaces;
wherein one of the planar surfaces of the first electric conductor adjoins one of the planar surfaces of the additional first electric conductor; and
wherein the first electric conductor and the additional first electric conductor are aligned such that the receptacles are aligned to form a combined receptacle.

16. The conductor assembly of claim 15, wherein the second electric conductor comprises a tongue having opposing planar surfaces, the tongue being disposed in the combined receptacle such that the planar surfaces adjoin interior edges of the arms of the first electric conductor and the additional first electric conductor.

17. The conductor assembly of claim 15, wherein the first electric conductor and the additional first electric conductor are connected to a base plate having a bottom surface configured for adherence to a metal pad of a printed circuit board.

18. The conductor assembly of claim 17, wherein the first electric conductor, the additional first electric conductor and the base plate are integrally joined together and are parts of a monolithic structure.

19. The conductor assembly of claim 1, wherein the arms of the first electric conductor are joined to a first side of a bar and wherein a plurality of press-fit fasteners is joined to a second side of the bar.

20. The conductor assembly of claim 1, wherein the first electric conductor further comprises a second connection portion configured to be crimped over a metal wire to make a connection thereto.

21. (canceled)

22. An electric motor comprising the conductor assembly of claim 1, wherein the electric motor further comprises:
a printed circuit board for distributing power, the printed circuit board having a metal pad to which the first electric conductor is surface mounted; and
an outer housing from which the second electric conductor extends.
